(19) United States
(12) Patent Application Publication
(10) Pub. No.: US 2013/0222336 A1
(43) Pub. Date: Aug. 29, 2013

(54) Compensated Linear Interpolation of Capacitive Sensors of Capacitive Touch Screens

(71) Applicants: Ronald Francis Cormier, JR., Vail, AZ (US); Michael Douglas Snedeker, Tucson, AZ (US)

(72) Inventors: Ronald Francis Cormier, JR., Vail, AZ (US); Michael Douglas Snedeker, Tucson, AZ (US)

(73) Assignee: TEXAS INSTRUMENTS INCORPORATED, Dallas, TX (US)

(21) Appl. No.: 13/613,840

(22) Filed: Sep. 13, 2012

Related U.S. Application Data
(60) Provisional application No. 61/602,693, filed on Feb. 24, 2012.

(51) Int. Cl. G06F 3/044

(52) U.S. Cl. 345/174

(57) ABSTRACT

An apparatus includes a capacitive touch screen (CTS); a touch screen interpolator (TSI) coupled to the CTS; a touch screen capacitive memory (TSCM) coupled to the touch screen interpolator, wherein the interpolator is configured to: interpolates a value based on data points correlated to at least three nodes: a magnitude change of capacitance of a node having the largest magnitude change; a position of the largest magnitude of change node; a change of magnitude of capacitance of a first closest neighbor node; and a change of magnitude of capacitance of a second closest neighbor node.

### PRIORITY

This application claims priority to U.S. Provisional Application No. 61/602,693 filed Feb. 24, 2012, entitled “Compensated Linear Interpolation for Capacitive Sensors”, which is incorporated by reference in its entirety.

### TECHNICAL FIELD

This Application is directed, in general, to capacitive touch screens and, more specifically, to a compensated linear interpolation of capacitive sensors of capacitive touch screens.

### BACKGROUND

FIG. 1 illustrates a prior art capacitive touch screen. As is illustrated, a capacitive touch screen has a horizontal axis and a vertical axis. There is also a node 105 that intersects both the horizontal and vertical axis. This is a node wherein a change of a capacitive measurement value may be measured for a capacitive sensor of the touch screen.

However, in the prior art, problems can occur when trying to interpolate a touch position between nodes 105, 107. The magnitudes of node 105 and 107, along with other adjacent nodes, can be used to interpolate the position of a touch with resolution finer than the pitch, the distance between two adjacent nodes.

The biggest change in capacitance occurs at the node 105 when one is touching directly over the node 105. When moving away from the node 105, the capacitance value is going to decrease, and as one moves toward the node 105, that value is going to increase. In a situation when one is touching in the middle of two nodes, the two nodes 105, 107 are going to have the same magnitude of change of capacitance. Then, an interpolation can occur between the nodes 105, 107 upon a desired interpolation of a touch point between the two nodes.

However, a “basic linear” interpolation (described in more detail below) has one or more drawbacks. When one moves through the distance half way between two nodes 105, 107, it works well. However, when directly over a node, such as node 105, it is inaccurate.

In a “weighted” interpolation (also described in more detail below), the weighted works acceptably well for some typical purposes when over a node 105, 107. But the weighted interpolation has an error when one is between the node, such as the nodes 105, 107. One reason for this is that one is using a second side node for the “weighted” interpolation, and that second side node is always going to have some value, so it is going to pull that value away from the actual touch position. For example, the pitch on the nodes can be about 5 millimeters, which roughly corresponds to half a diameter of a finger size plus a little leeway. A finger can be typically 8 or 9 millimeters in diameter. A finger can be big enough that one is going to be interacting with the nodes on either side of the selected node.

FIG. 2A-2B illustrates an example of a prior art calculation of interpolation using the “basic linear” interpolation and a “weighted” interpolation. As is illustrated for FIG. 2A, three data points will be used: (x1, z1), (x2, z2), and (x3, z3). The “x” coordinates correspond to a column or row, and the “z” coordinate corresponds to magnitudes of the touch.

(x2, z2) represents the peak magnitude of a node of a set of nodes. Touches will be either directly over (x2, z2) wherein, for example, x=2 (i.e., the node having the strongest “touch is occurring in the second row). In the illustrated examples, a touch will be either directly over (x2,z2) wherein x=2 or in the middle of (x2, z2) and (x3, z3), x=2.5

FIG. 2B illustrates a prior art “basic” interpolation and a prior art “weighted” interpolation.

FIG. 2Ci illustrates in the prior art what happens when a touch occurs between x2 and x3, for example nodes 105 and 107 of FIG. 1. As is illustrated, the “basic” interpolation method yields a correct result (x=2.500) but the “weighted” interpolation method does not (x=2.214.)

FIG. 2Cii illustrates in the prior art what happens when a touch directly over a node, such as a nod 105 of FIG. 1. As is illustrated, the “weighted” interpolation method yields a correct result (x=2.000) but the “basic” interpolation method does not (x=2.263.)

As alluded to above, a problem with the basic approach of interpolation is that the side node is always known and it always has some nonzero value. So, in the basic method, an output of the basic interpolation is that one can approach being directly over a node but one is never going to get there according to this interpolation approach. So that is the problem with the basic value that we use in the basic equation.

Then the weighted method gives good results directly over the node. It will tell you exactly where you are at, but as one go directly between two nodes, one are using three nodes, you are using the center, and both left and right, so when one are directly between the center of two nodes, those two nodes should have the exact same value in an ideal world. Well now, the third node one using either on the far left or far right side has a nonzero value, that non zero value is going to pull you off from being directly in the middle, so you can approach being directly between those two, but you can never be directly between those two. And so because of that there is an inherent error there. There are two boundary conditions to be considered, being directly of a node, or being in the middle of two nodes. The of the prior art is good at one boundary while having an error at the opposite boundary.

Therefore, there is a need in the art as understood by the present inventors to addresses at least some of the concerns of the usage of the prior art.

### SUMMARY

A first aspect provides An apparatus includes a capacitive touch screen (CTS); a touch screen interpolator (TSI) coupled to the CTS; a touch screen capacitive memory (TSCM) coupled to the touch screen interpolator, wherein the interpolator is configured to: interpolates a value based on data points correlated to at least three nodes: a magnitude change of capacitance of a node having the largest magnitude change; a position of the largest magnitude of change node; a change of magnitude of capacitance of a first closest neighbor node of an axis; and a change of magnitude of capacitance of a second closest neighbor node of the same axis.

A second aspect provides a method, comprising: determining a position of a node of a largest magnitude of capacitive change on an axis of a capacitive touch screen, subtracting a capacitive change of a first nearest node of the axis, of the node of the largest magnitude of capacitive change from a second nearest node of the largest magnitude of capacitive change of the axis to generate a first value, determining a lesser of a magnitude of change of capacitance between the first nearest node and the second nearest node, subtracting the lesser of the magnitudes of change from the first value to generate a second value; dividing first value by the second value and then multiplying by substantially half to generate a third value; add third value to the position of the node of the largest magnitude of capacitive change to generate a determined placement of a touch on the capacitive touch screen.

A third aspect provides an apparatus, comprising: a capacitive touch screen (CTS); a touch screen interpolator (TSI) coupled to the CTS; a touch screen capacitive memory (TSCM) coupled to the touch screen interpolator, wherein the interpolator is configured to: employ a characteristic of a neighboring capacitive point to substitute for a capacitive point on point beyond a last capacitive intersection conveyed from the TSCM, wherein the interpolator interpolates a value based on the four data points correlated to at least three nodes: a magnitude change of capacitance of a node having the largest magnitude change; a position of the largest magnitude of change node; a change of magnitude of capacitance of a first closest neighbor node of an axis; and a change of magnitude of capacitance of a second closest neighbor node of the same axis, wherein, wherein the capacitive touch screen has 10 rows of nodes of a first axis and 6 columns of nodes on a second axis, and wherein each of the nodes has a pitch of substantially five millimeters.

### BRIEF DESCRIPTION OF THE DRAWINGS

Reference is now made to the following descriptions:

FIG. 1 illustrates a prior art capacitive touch screen;

FIG. 2A-2C ii illustrate examples of employment of prior art “basic” interpolation and “linear” interpolation algorithms with use of a capacitive touch screen;

FIG. 3A illustrates a system that employs a compensated linear interpolation for a capacitive touch screen;

FIG. 3B illustrates an algorithm employed with the capacitive touch screen of FIG. 3A

FIG. 4A illustrates the results of calculations of a touch directly over a node wherein one of the calculations include the “compensated linear” interpolation;

FIG. 4B illustrates the results of calculations of a touch between two nodes wherein one of the calculations include the “compensated linear” interpolation; and

FIG. 5 illustrates one aspect of an employment of a method of a “compensated linear” interpolation with a capacitive touch screen.

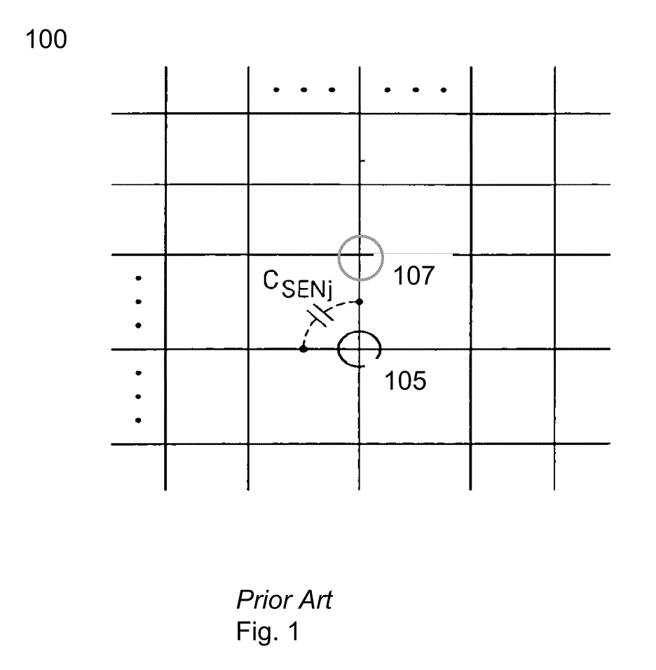

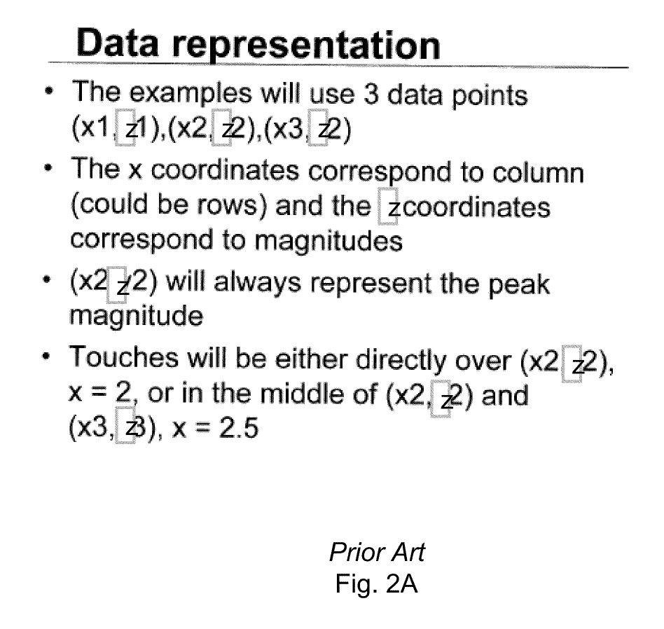

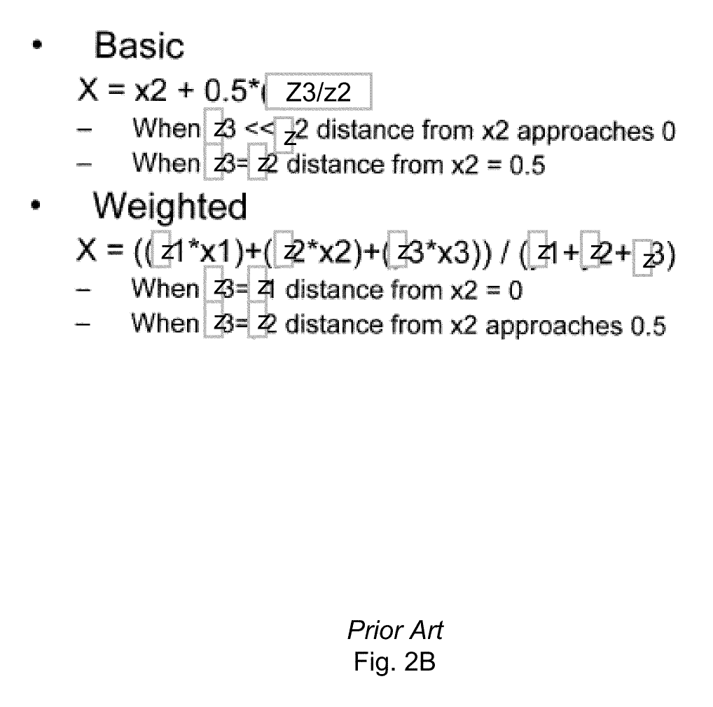

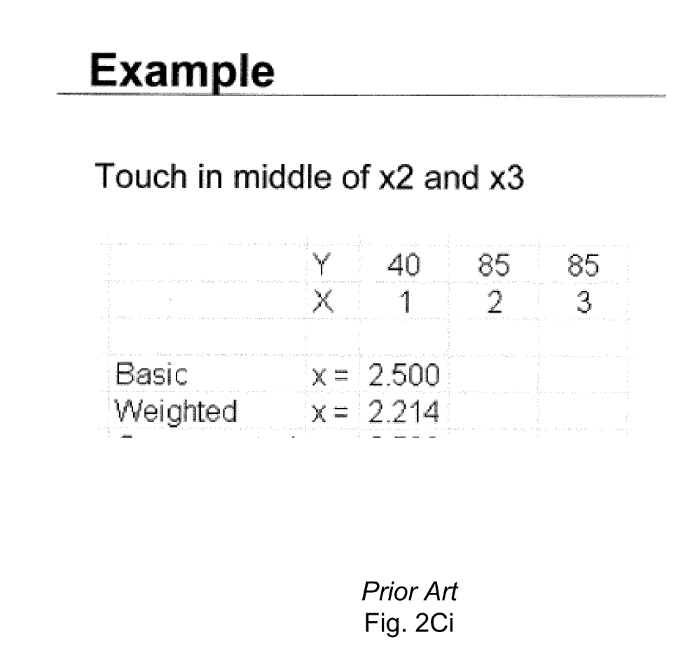

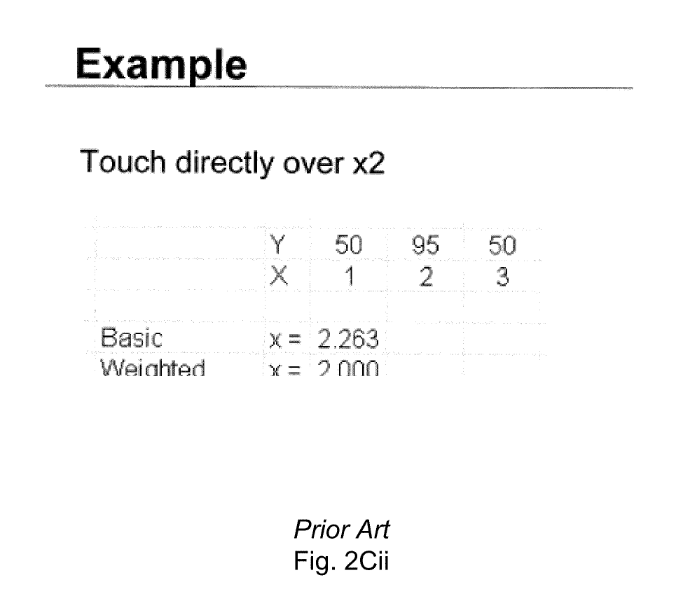

### DETAILED DESCRIPTION

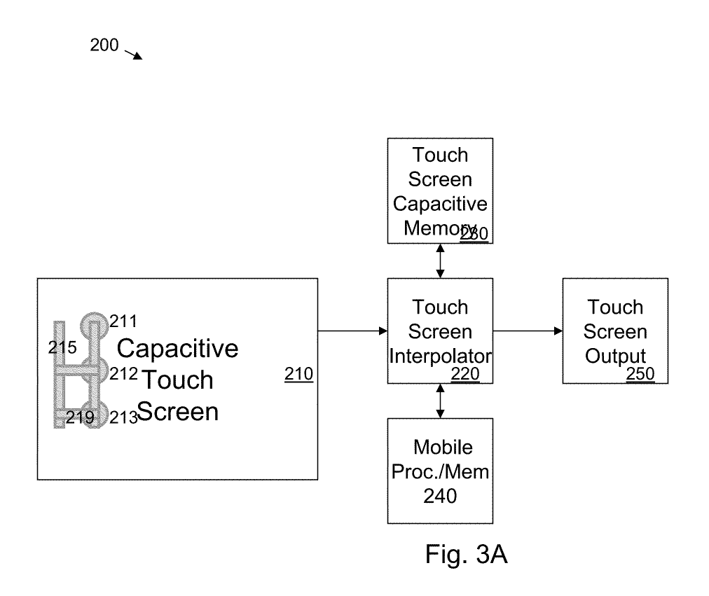

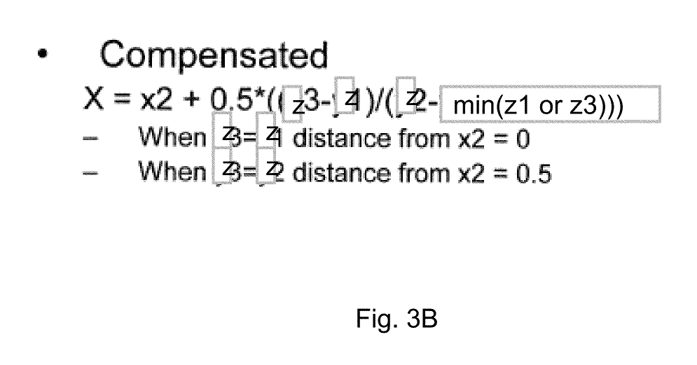

Turning to FIG. 3A, illustrated is one aspect of a system 200 employing a “compensated linear” interpolation algorithm for determining a touch on a capacitive screen, constructed according to the principles of the present Application.

The system includes a capacitive touch screen (CTS) 210. In one aspect, the CTS 210 includes a plurality of horizontal bars 215 and vertical bars 219, although the CTS may be manufactured according to other approaches. The CTS also includes example nodes 211, 212, 213.

A touch screen interpolator (TSI) 220 is coupled to the CTS 210. The TSI 220 employs the “compensated linear” interpolation algorithm to determine where on the CTS 210 a touch occurred. The interpolator 220 is configured to: interpolates a value based on data points correlated to at least three nodes: a) a magnitude change of capacitance of a node having the largest magnitude change; b) a position of the largest magnitude of change node; c) a change of magnitude of capacitance of a first closest neighbor node; and d) a change of magnitude of capacitance of a second closest neighbor node. The “compensated linear” interpolation algorithm will be described below regarding FIG. 3B in more detail.

The system 200 includes a touch screen capacitive memory (TSCM) 230 coupled to the touch screen interpolator 220. Generally, the TSCM 230 stores interpolations that are determined by the TSI 220.

The system 200 further includes a mobile processor/memory 240 is also coupled to the TSI 220, and can also be coupled to the TSCM 230. The mobile processor/memory 240 employs interpolated values that correlates to a Determination of Placement of Touch to Make Alteration of Behavior Of Mobile Device or Presentation to User.

The system 200 still further includes a touch screen output 250. The touch screen output can be overlayed on the capacitive touch screen 210. The touch screen output 250 presents options to the user, or other information, which can prompt the user to make a selection of the CTS 210 at one or more nodes.

FIG. 3B illustrates the compensated linear interpolation algorithm employed by the TSI 220. According to FIG. 3B,

X=x2+0.5*((z3−z1)/(z2−min{z1 or z3}))
a) wherein “X” is the distance location of the node with the largest magnitude of capacitance change;
b) z1 is the magnitude of change of capacitance of the first neighboring node of x2,
c) z2 is the magnitude of change of capacitance of x2; and
d) z3 is the magnitude of change of capacitance of the second neighboring node of x2,
e) min{z1 or z3}—chooses the minimum magnitude of “z1” or “z3.”

In the illustrated aspect, z1 could be a change of magnitude of capacitance of node 211, z2 could be a c a change of magnitude of capacitance of node 212, and z3 could be a change of magnitude of capacitance of node 213.

In the system 200, one's fingers are interacting with those side nodes 211, 212, so there are non zero values. For example, the CTS 210 has a series of columns, 1-6, and the node 212 is present in column 2. The largest delta, the largest change in capacity, happens in column 2, and that is x2. So, giving the examples of the magnitudes of what we have directly over a node, if we have a magnitude of 100, then column one and column three [24:21] both have a value of sixty, that could be z1 and z3 in that example of a perfect/non real world situation.

The TSI 220 looks for peak nodes. The TSI 220 finds the node, such as node 212, that has the largest change. The touch is directly close to this node 212, either directly over it or some distance from it, but it is closest to this node because the node 212 in this example has the biggest change. Then in one aspect, the TSI 220 interpolates using the “compensated” linear interpretation to find the interpolation for the x and y coordinates.

Generally, what the “compensated linear” interpolation approach does is employ values of the three nodes, and its takes the smallest of the three. This smallest value is subtracted from all three values. This reduces one node to zero. Now, what will happen with this is when you are directly over the node, when the two side nodes are equal, both of the side nodes will become zero. So now, in that case the equation breaks down into what the “weighted case” does, and it gives an accurate interpolation directly over the node. And in the case where the touch is between two nodes, when the center node 211 and the side node 212 are equal, the TSI 220 is subtracting the same value, the third smaller value, from both of those. This becomes similar to the “basic” method and gives and accurate interpolation between two nodes.

In the compensated linear interpolation, as discussed above, both boundary conditions are fixed. They are both perfect. Now the only errors between the boundary conditions are because of doing a linear interpolation on a non-linear function. The compensated linear interpolation has also minimized an error of interpolation, because instead of the error getting bigger and bigger as one approached the boundary, it is going to get bigger as it approaches the center, but it reduces as you approach the other boundary. So it minimizes the error. The boundary conditions set limits on the error.

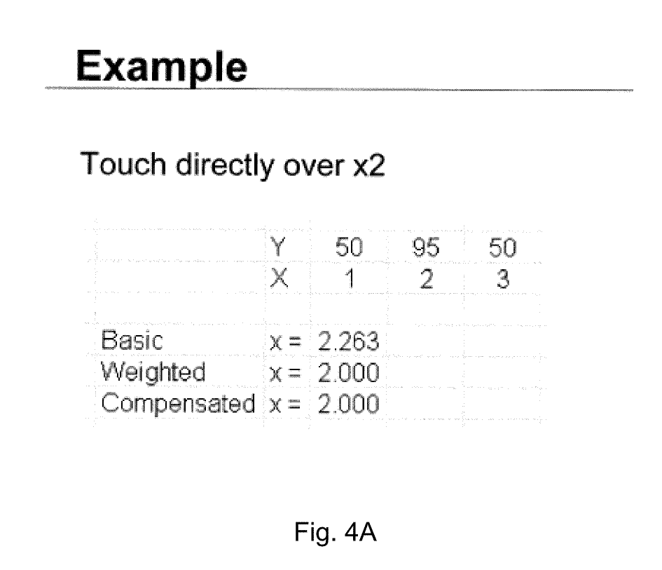

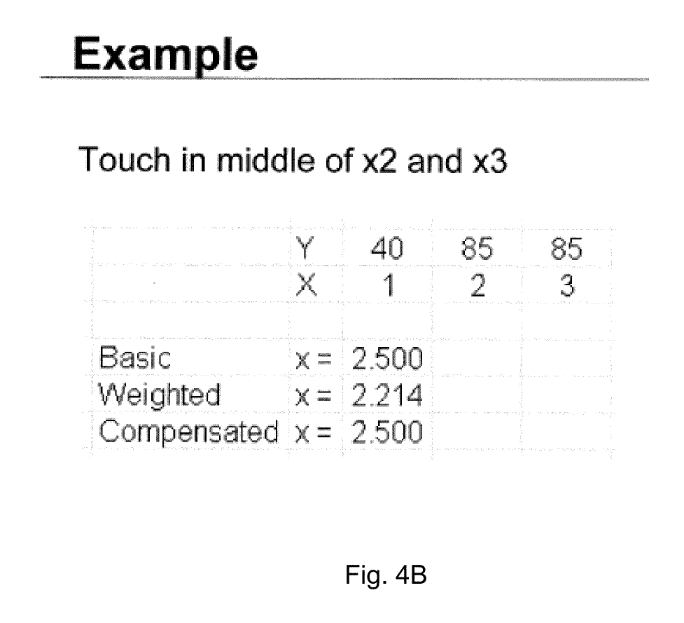

FIG. 4A continues the example of FIG. 3Ci, but with employment of the “compensated linear” interpolation. As is illustrated, the compensated linear interpolation yields a correct result of “2.500” for a first boundary condition, that of a touch in a middle of x2 and x3.

FIG. 4B also continues the example of FIG. 3Ci, but with employment of the “compensated linear” interpolation. As is illustrated, the compensated linear interpolation yields a correct result of “2.000” for a first boundary condition, that of a touch directly over x2.

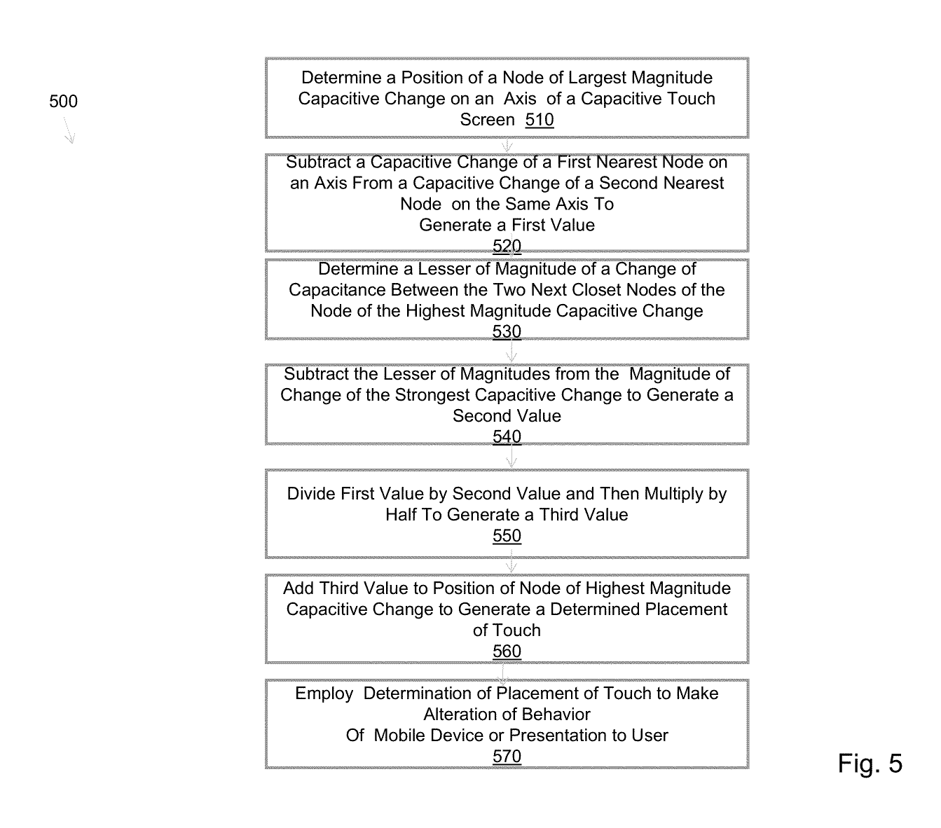

FIG. 5 illustrates a method 500 for interpolating a touch on a capacitive screen, such as the CTS 210.

In a step 510, a position of a node of a largest magnitude of capacitive change on an axis of a capacitive touch screen, such as an x axis (a “row”) or a y axis (a “column”) is determined. This can be, for example, node 212.

In a step 520, a capacitive change of a first nearest node is subtracted from a capacitive change of a second nearest node to generate a first value. For example, node 211 can be subtracted from node 213.

In a step 530, a determination occurs of a lesser of magnitude between a change of a capacitance of the next two closest nodes of the node of the highest magnitude of capacitive change. For example, node 211 can be less than node 213.

In a step 540, the lesser of magnitude is subtracted from the magnitude of change of the strongest capacitive change, such as node 212, to generate a second value.

In a step 550, the first value is divided by the second value and is then multiplied by substantially one half to generate a third value.

In a step 560, the third value is added to the position of the node of the highest magnitude capacitive change to generate a determined placement of touch.

In a step 570, a determination of placement of the touch is employed to make an alteration of behavior of the mobile device or a presentation to the user.

Those skilled in the art to which this application relates will appreciate that other and further additions, deletions, substitutions and modifications may be made to the described embodiments.

What is claimed is:

1. An apparatus, comprising:
a capacitive touch screen (CTS);
a touch screen interpolator (TSI) coupled to the CTS;
a touch screen capacitive memory (TSCM) coupled to the touch screen interpolator,
wherein the interpolator is configured to: interpolates a value based on data points correlated to at least three nodes:
a magnitude change of capacitance of a node having the largest magnitude change;
a position of the largest magnitude of change node;
a change of magnitude of capacitance of a first closest neighbor node of an axis; and
a change of magnitude of capacitance of a second closest neighbor node of the same axis.

2. The apparatus of claim 1, wherein the capacitive touch screen comprises a plurality of horizontal and vertical bars.

3. The apparatus of claim 1, wherein a difference between a magnitude of the first neighbor node and the second neighbor node is determined to generate a first value.

4. The apparatus of claim 3, wherein a lesser of magnitude of the first closest neighbor node and the second closest neighbor node is determined.

5. The apparatus of claim 4, wherein the magnitude of the strongest node is subtracted from the lesser of magnitude to generate a second value.

6. The apparatus of claim 5, wherein the first value is divided by the second value, multiplied by substantially 0.5 and added to the position of the strongest capacitive change to generate a determined placement of touch on the capacitive touch screen.

7. The apparatus of claim 1, further comprising wherein the interpolator interpolates a touch position for both a row of the capacitive touch screen and a column of the capacitive touch screen.

8. A method, comprising:
determining a position of a node of a largest magnitude of capacitive change on an axis of a capacitive touch screen,
subtracting a capacitive change of a first nearest node of the axis, of the node of the largest magnitude of capacitive change from a second nearest node of the largest magnitude of capacitive change of the axis to generate a first value,
determining a lesser of a magnitude of change of capacitance between the first nearest node and the second nearest node,
subtracting the lesser of the magnitudes of change from the first value to generate a second value;
dividing first value by the second value and then multiplying by substantially half to generate a third value;
add third value to the position of the node of the largest magnitude of capacitive change to generate a determined placement of a touch on the capacitive touch screen.

9. The method of claim 8, further comprising determining a position of the node of the highest magnitude of capacitive gain on a first axis and a second axis, wherein the first axis is a column and the second axis is a row of the capacitive touch screen.

10. The method of claim 8, further comprising employing the determination of placement of touch to make an alteration of behavior of the mobile device or an alternation of a presentation to a user.

11. The method of claim 8, further comprising removing a touch of the screen, wherein the touch is a first touch, and touching a second node of the capacitive touch screen, wherein the touched node has a highest magnitude change of capacitance at that point in time.

12. The method of claim 8, wherein a pitch between nodes of the capacitive touch screen is substantially five millimeters in both a horizontal axis and a vertical axis.

13. The method of claim 8, wherein the capacitive touch screen has 10 rows of nodes and 6 columns of nodes.

14. An apparatus, comprising:
a capacitive touch screen (CTS);
a touch screen interpolator (TSI) coupled to the CTS;
a touch screen capacitive memory (TSCM) coupled to the touch screen interpolator,
wherein the interpolator is configured to:
employ a characteristic of a neighboring capacitive point to substitute for a capacitive point on point beyond a last capacitive intersection conveyed from the TSCM,
wherein the interpolator interpolates a value based on the four data points correlated to at least three nodes:
a magnitude change of capacitance of a node having the largest magnitude change;
a position of the largest magnitude of change node;
a change of magnitude of capacitance of a first closest neighbor node of an axis; and
a change of magnitude of capacitance of a second closest neighbor node of the same axis,
wherein, wherein the capacitive touch screen has 10 rows of nodes of the same axis and 6 columns of nodes on another axis, and
wherein each of the nodes has a pitch of substantially five millimeters.

15. The apparatus of claim 14, wherein the capacitive touch screen comprises a plurality of horizontal and vertical bars.

16. The apparatus of claim 15, wherein a difference between a magnitude of the first neighbor node and the second neighbor node is determined to generate a first value.

17. The apparatus of claim 16, wherein a lesser of magnitude of the first closest neighbor node and the second closest neighbor node is determined.

18. The apparatus of claim 17, wherein the magnitude of the strongest node is subtracted from the lesser of magnitude to generate a second value.

19. The apparatus of claim 18, wherein the first value is divided by the second value, multiplied by substantially 0.5 and added to the position of the strongest capacitive change to generate a determined placement of touch on the capacitive touch screen.

20. The apparatus of claim 14, further comprising wherein the interpolator interpolates a touch position for both a row of the capacitive touch screen and a column of the capacitive touch screen.
